(19) United States
(12) Patent Application Publication
(10) Pub. No.: US 2015/0382414 A1
(43) Pub. Date: Dec. 31, 2015

(54) Sequential Linear LED System With Low Output Ripple

(71) Applicant: Microchip Technology Inc., Chandler, AZ (US)

(72) Inventor: Scott Lynch, Half Moon Bay, CA (US)

(21) Appl. No.: 14/748,175

(22) Filed: Jun. 23, 2015

Related U.S. Application Data
(60) Provisional application No. 62/018,531, filed on Jun. 27, 2014.

(51) Int. Cl. H05B 33/08

(52) U.S. Cl. CPC H05B 33/0812; H05B 33/0845

(57) ABSTRACT

A sequential linear light emitting diode (LED) system with a low output ripple is disclosed. In one embodiment, the a sequential linear LED system comprises a bridge rectifier for generating a DC voltage, a diode for receiving the DC voltage, a capacitor coupled to the diode, a current regulator coupled to the capacitor for controlling the charging of the capacitor, and a plurality of segments coupled to the diode, each segment comprising an LED string and current regulator.

### CROSS REFERENCE TO RELATED APPLICATION

This patent application claims priority to U.S. Provisional Application No. 62/018,531, filed on Jun. 27, 2014, and titled “Sequential Linear LED System with Low Output Ripple,” which is incorporated herein by reference in its entirety.

### TECHNICAL FIELD

A sequential linear light emitting diode (LED) driver with a low output ripple is disclosed.

### BACKGROUND OF THE INVENTION

With reference to FIG. 1, prior art LED system 100 is depicted. Prior art LED system 100 comprises AC voltage source 110, bridge rectifier 120, and diode 130. Prior art LED system 100 further comprises a plurality of LED strings, here shown as LED string 141, LED string 142, LED string 143, and LED string 144. A current regulator is attached after each LED string, here shown as current regulator 151, current regulator 152, current regulator 153, current regulator 154, and current regulator 155. It is to be understood that prior art LED system 100 can comprise a greater or fewer number of LED strings and current regulators than what is shown.

As the voltage output of bridge rectifier 120 increases from 0V, LED string 141 is forward biased such that the LEDs in LED string 141 emit light and current is controlled by current regulator 151. When the voltage becomes sufficiently high, LED string 142 also will become forward biased such that the LEDs in both LED string 141 and LED string 142 emit light. At that point, current regulator 152 will cause current regulator 151 to shut down. As the voltage increases further, the same happens for the remaining LED strings and current regulators, until LED strings 141, 142, 143, and 144 are emitting light, current is drawn by current regulator 155, and current regulators 151, 152, 153, and 154 are turned off.

One drawback of prior art LED system 100 is that when the voltage provided by AC voltage source 110 approaches 0V, the total light output from all LED strings will be zero. That is, LED system 100 will stop emitting light, which results in a “strobing” or “ripple” effect. This is extremely undesirable from a user's point of view.

What is needed is an improved LED system with a decreased strobing or ripple effect.

### SUMMARY OF THE INVENTION

The present invention reduces or eliminates the strobing or ripple effect through the use of a fill capacitor that is charged by a current regulator.

### BRIEF DESCRIPTION OF THE DRAWINGS

FIG. 1 depicts a prior art LED system.

FIG. 2 depicts an embodiment of an LED system comprising a fill capacitor charged by a current regulator.

FIG. 3 depicts another embodiment of an LED system comprising a fill capacitor charged by a current regulator.

### DETAILED DESCRIPTION OF THE PREFERRED EMBODIMENT

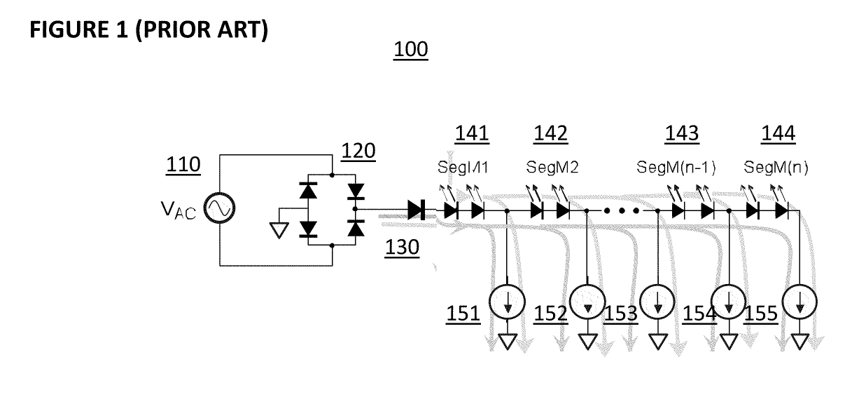

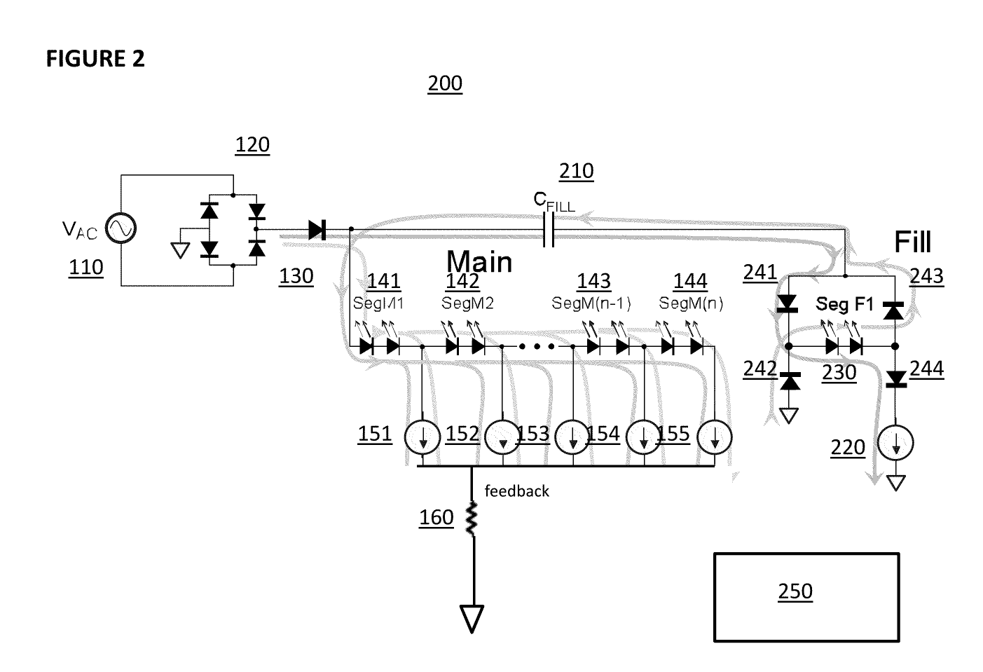

With reference to FIG. 2, LED system 200 is depicted. LED system 200 comprises many of the same components in prior art LED system 100 shown in FIG. 1. LED system 200 further comprises fill capacitor 210, current regulator 220, LED string 230, and diodes 241, 242, 243, and 244. LED string 230 is optional and does not need to be used. If used, LED string 230 could comprise one LED or multiple LEDs. Moreover, one or more additional LED strings could be added to LED string 230. Current regulators 151, 152, 153, 154, and 155 are coupled to resistor 160, which in turn is coupled to ground. Thus, current regulators 151, 152, 153, 154, and 155 share a common path to ground.

During operation, as the voltage from bridge rectifier 120 increases from 0V, current will flow into fill capacitor 210 and through diode 241, through LED string 230, through diode 244, and through current regulator 220. Current also will flow into the lower circuit, starting with LED string 141 and current regulator 151. By controlling current regulator 220 and current regulators 151, 152, 153, 154, and 155 using control circuit 250, the system can allocate current between charging fill capacitor 210 and providing power to LED strings 141, 142, 143, and 144 and can maximize the power factor of LED system 200 (such that voltage and current usage are in phase with one another). Thus, current regulator 220 can be used to control the charging of fill capacitor to maintain a high input power factor.

When the voltage output by bridge rectifier 120 approaches the zero crossings (the situation in which prior art LED system 100 would emit no light), the charge stored in fill capacitor can be used to power LED strings 141, 142, 143, and 144. Current will flow from ground through diode 242, LED string 230, diode 243, through fill capacitor 210 and into LED strings 141, 142, 143, and 144. The voltage provided by fill capacitor 210 will be at the peak voltage of fill capacitor 210. Thus, unlike in the prior art, LED strings 141, 142, 143, and 144 can continue to emit light even in periods when AC voltage source 110 is producing a voltage near 0 V.

As fill capacitor 210 is discharged, its voltage will decrease. As the voltage of fill capacitor 210 decreases, LED strings 141, 142, 143, and 144 will stop conducting one-by-one, in reverse order starting with LED string 144. Thus, LED string 144 will stop emitting light when the voltage of fill capacitor 210 drops below a certain level. At that point, current regulator 155 will stop drawing current and will activate current regulator 154. Current regulator 154 will then draw current until LED string 143 stops emitting light, at which point current regulator 154 will stop drawing current and will activate current regulator 153. This process continues until only LED string 141 and current regulator 151 are active, although at some point the voltage from bridge rectifier 120 will exceed the voltage being provided by fill capacitor 210.

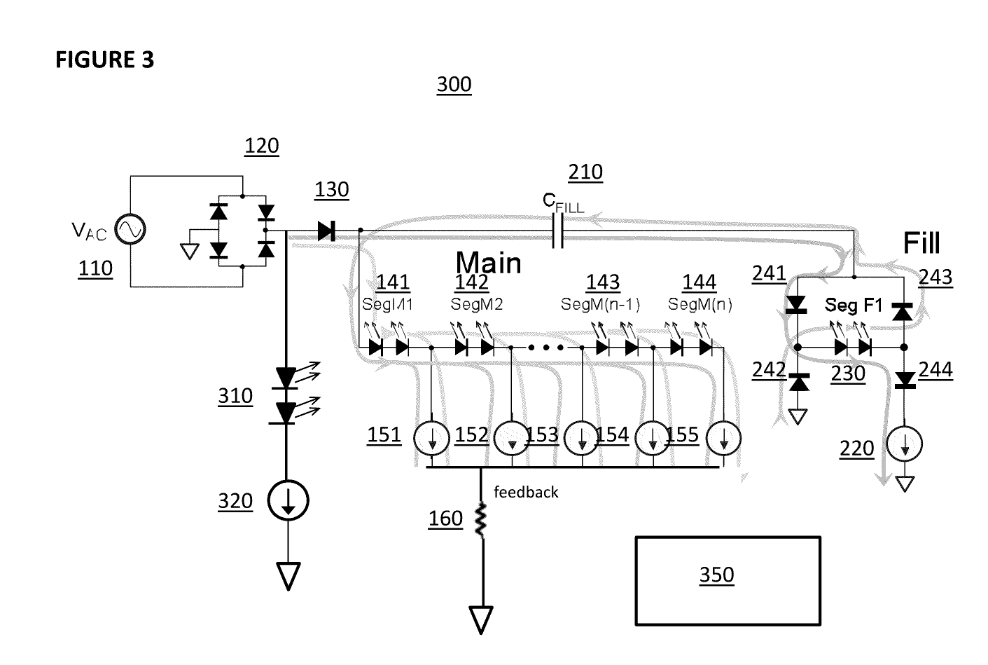

With reference to FIG. 3, another embodiment is depicted. LED system 300 comprises many of the same components as LED system 200. LED system 300 also comprises LED string 310, diode 130, current regulator 320, and control circuit 350. Control circuit 350 controls current regulators 151, 152, 153, 154, 155, 220, and 320. The purpose of LED string 210 and current regulator 320 is to reduce the total harmonic distortion (THD) of the system and to maintain total light output over time.

LED system 200 and LED system 300 minimize or eliminate the output ripple and “strobe effect” of prior art LED system 100. In addition, a greater power factor is achieved. LED system 300 further reduces the THD of the system.

What is claimed is:

1. A light emitting diode (LED) system comprising:
an alternating current voltage source;
a bridge rectifier coupled to the alternating current voltage source;
a plurality of LED strings coupled to an output of the bridge rectifier, each of the plurality of LED strings comprising one or more LEDs;
a plurality of current regulators, each of the plurality of current regulators coupled to one of the plurality of LED strings to control current through that LED string;
a capacitor coupled to the output of the bridge rectifier and to an ancillary current regulator;
wherein when the output of the bridge rectifier is reverse-biased, the capacitor provides a positive voltage to the plurality of LED strings to initially cause one or more the plurality of LED strings to emit light after the output of the bridge rectifier becomes reverse-biased.

2. The system of claim 2, further comprising a control circuit for controlling the plurality of current regulators and the ancillary current regulator coupled to the capacitor to allocate current between charging the capacitor and providing power to the plurality of LED strings.

3. The system of claim 2, wherein the control circuit allocates current between charging the capacitor and providing power to the plurality of LED strings to maintain a high input power factor.

4. The system of claim 1, further comprising a resistor coupled to each of the plurality of current regulators to provide a common path to ground.

5. The system of claim 1, further comprising an ancillary LED string comprising one or more LEDs coupled between the capacitor and the ancillary current regulator.

6. The system of claim 5, further comprising a diode coupled between the capacitor and the ancillary LED string and a diode between the ancillary LED string and the ancillary current regulator.

7. The system of claim 6, further comprising a diode coupled between ground and the ancillary LED string and another diode coupled between the capacitor and ancillary LED string.

8. The system of claim 7, wherein when the main diode is reverse-biased, current initially flows from ground through a diode, the ancillary LED string, a diode, the capacitor, and one or more of the plurality of LED strings.

9. The system of claim 1, further comprising a second ancillary LED string coupled between the bridge rectifier and main diode.

10. The system of claim 9, further comprising a current regulator coupled to the second ancillary LED string and to the control circuit.

11. A method of operating a light emitting diode (LED) system comprising:
concurrently provide current to a capacitor and a first LED string, the first LED string comprising one or more LEDs;
while an output of a bridge rectifier is still forward biased, providing current to a first LED string and one or more additional LED strings, each of the one or more additional LED strings comprising one or more LEDs;
reverse biasing the output of the bridge rectifier and providing current from the capacitor to the first LED string and the one or more additional LED strings;
when the output of the bridge rectifier is still reverse biased, providing current from the capacitor only to the first LED string

12. The method of claim 11, further comprising:
allocating, by a control circuit, current between charging the capacitor and providing power to the first LED string and the one or more additional LED strings.

13. The method of claim 12, wherein the allocating step maintains a high input power factor.

14. The method of claim 11, wherein a resistor coupled to the first LED string and the one or more additional LED strings provides a common path to ground.

15. The method of claim 11, further comprising:
when the output of the bridge rectifier is forward biased, providing current to an ancillary LED string comprising one or more LEDs coupled to the capacitor.

16. The method of claim 15, wherein a diode is coupled between the capacitor and the ancillary LED string.

17. The method of claim 16, wherein a diode is coupled between ground and the ancillary LED string and a diode is coupled between the capacitor and the ancillary LED string.

18. The method of claim 17, further comprising:
when the output of the bridge rectifier is reverse-biased, providing current from ground through a diode, the ancillary LED string, a diode, the capacitor, and at least the first LED string.

19. The method of claim 11, further comprising:
providing current to a second ancillary LED string coupled between the bridge rectifier and main diode.

20. The method of claim 19, further comprising:
allocating, by a control circuit, current between charging the capacitor and providing power to the first LED string, the one or more additional LED strings, and the second ancillary LED string.
